(19) United States
(12) Patent Application Publication
(10) Pub. No.: US 2012/0244467 A1
(43) Pub. Date: Sep. 27, 2012

(54) TONER FOR ELECTROSTATIC USE

(75) Inventors: Jae Bum Park, Daejeon-city (KR); Young Jae Kwon, Daejeon-city (KR); Dae Woong Choi, Daejeon-city (KR)

(73) Assignee: SAMSUNG FINE CHEMICALS CO., LTD., Ulsan (KR)

(21) Appl. No.: 13/508,516

(22) PCT Filed: Dec. 16, 2010
(86) PCT No.: PCT/KR10/09034

§ 371 Date: May 7, 2012

(30) Foreign Application Priority Data
Dec. 16, 2009 (KR) 10-2009-0125687

(51) Int. Cl. G03G 9/087; G03G 13/16

(52) U.S. Cl. 430/109.3; 430/109.1; 430/125.3

(57) ABSTRACT

Toner particles having excellent cleaning properties and glossing properties. The toner particles include a binder resin, a releasing agent, and a colorant, wherein toner particles satisfy the following conditions.

50° C.≦T_{1/2}−T_{g}≦100° C. (1)

50° C.≦T_{g}60° C. (2)

### TECHNICAL FIELD

The present invention relates toner particles for developing an electrostatic image, a developer for forming an electrophotographic image including the same, and a method of forming an electrophotographic image using the developer, and more particularly, to toner particles having excellent fixing properties, cleaning properties, and glossing properties, a developer for forming an electrophotographic image including the same, and a method of forming an electrophotographic image using the developer.

### BACKGROUND ART

A variety of electrophotographic printing systems have been reported. By using an electrophotogarphic printing system, an electrostatic latent image is formed on a photoreceptor using a photoconductive material via various methods, the electrostatic latent image is developed by supplying toner thereto to form a visual toner image, the toner image is transferred onto a transfer image-receiving medium such as paper, and the toner image is fixed on the medium by applying heat and/or pressure thereto.

As the amount of heat required for fixing toner images decreases, heat applied from a heating roller is reduced, and pressing time decreases to save energy, toner is required to have excellent fixing properties at a low temperature.

In addition, developed images may be exposed to excess heat if the developed images contact with the heating roller for a long period of time in a high-speed device that is out of order, and thus, a sufficient hot offset resistance is required.

If a softening point or molecular weight of a binder resin is increased in order to improve a hot offset resistance, a cold offset resistance and fixing properties at a low temperature may deteriorate. On the other hand, if the softening point or glass transition temperature of the binder resin is reduced in order to improve a cold offset resistance and fixing properties at a low temperature, a hot offset resistance and blocking resistance may deteriorate.

Meanwhile, great efforts have been devoted to improve cleaning properties and glossing properties that affect the quality of printing by adjusting the shape of toner. However, the results are not satisfactory.

### DETAILED DESCRIPTION OF THE INVENTION

### Technical Problem

The present invention provides toner particles having excellent fixing properties at a low temperature, excellent cleaning properties, and excellent glossing properties.

The present invention also provides a developer for developing an electrostatic image including the toner particles.

The present invention also provides a method of forming an electrophotographic image using the developer for developing an electrostatic image.

### Technical Solution

According to an aspect of the present invention, there is provided toner particles including a binder resin, a releasing agent, and a colorant, wherein T_{1/2} obtained using a load extrusion-type capillary rheometer and a glass transition temperature T_{g} satisfy the following conditions:

50□≦T_{1/2}−T_{g}≦100□ (1)

50□≦T_{g}≦60□ (2)

The binder resin may include a styrene residue.

According to another aspect of the present invention, there is provided a developer for developing an electrostatic image including: the toner particles; and a carrier.

According to another aspect of the present invention, there is provided a method of forming an electrophotographic image, the method including forming a toner image by adhering toner particles onto the surface of a photoreceptor on which an electrostatic latent image is formed, and transferring the toner image to a transfer medium.

### Advantageous Effects

Toner particles according to embodiments of the present invention have excellent fixing properties at a low temperature, excellent cleaning properties, and excellent glossing properties.

### BRIEF DESCRIPTION OF THE DRAWINGS

The above and other features and advantages of the present invention will become more apparent by describing in detail exemplary embodiments thereof with reference to the attached drawing in which:

FIG. 1 is a graph illustrating a flow curve of a sample obtained using a temperature raising method using a load extrusion-type capillary rheometer.

### BEST MODE FOR CARRYING OUT THE INVENTION

Hereinafter, the present invention will now be described more fully with reference to the accompanying drawings, in which exemplary embodiments of the invention are shown

Hereinafter, toner particles according to exemplary embodiments of the present invention will be described in detail with reference to the accompanying drawing. As used herein, the term “and/or” includes any and all combinations of one or more of the associated listed items. Expressions such as“at least one of,” when preceding a list of elements, modify the entire list of elements and do not modify the individual elements of the list.

Toner particles according to an embodiment of the present invention include a binder resin, a releasing agent, and a colorant, wherein T_{1/2} obtained using a load extrusion-type capillary rheometer and a glass transition temperature T_{g} satisfy the following conditions.

50□≦T_{1/2}−T_{g}≦100□ (1)

50□≦T_{g}≦60□ (2)

The load extrusion-type capillary rheometer, which is a device simply measuring performance of a resin, such as thermal characteristics and viscosity, measures viscous resistance while melted materials are passing through a capillary. For example, a flow tester CFT-500 manufactured by Shimadzu Corporation may be used. The performance of a resin may be measured using this device and a temperature raising method by which temperature is increased at a constant rate as a processing time passes. While a sample is transformed from a solid zone, through a transition zone and a rubber-phases elastic zone, to a flow zone, the performance may consecutively be measured. Using this device, shear rate and viscosity may be measured at all temperatures in the flow zone.

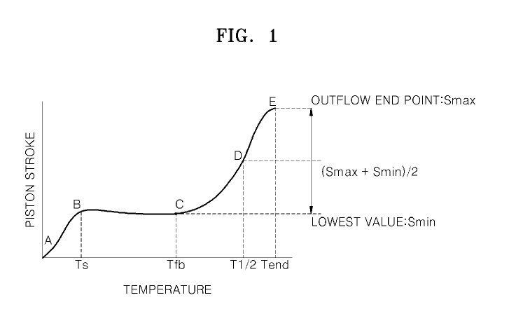

FIG. 1 is a graph illustrating a flow curve of a sample obtained using a temperature raising method using a load extrusion-type capillary rheometer.

AB region (softening curve) represents a stage in which a sample is deformed under compression load so that internal voids are gradually reduced.

Point B represents a temperature at which the internal voids disappear so that the sample has one transparent state or phase with a non-uniform stress distribution and a uniform appearance. Point B is an inflection point between the solid zone and the transition zone. This temperature is defined as a softening temperature (Ts).

BC region (stop curve) is a region in which a position of a piston is not significantly changed within a limited time period and the sample begins to flow from a die. The sample includes a rubber-phase elastic zone. A crystalline polymer has a short rubber-phase elastic zone and a Ts similar to a temperature at which the sample begins to flow, as described below.

Point C represents a temperature at which the sample beings to flow from a die of a flow meter due to the reduction of viscosity. This temperature is defined as a flow beginning temperature (Tfb).

CDE region (flow out curve) is a region in which the sample begins to flow from the die as an irreversible viscous flow.

The melting point (T1/2) is a temperature corresponding to a half piston stroke of the flow meter between the temperature at which the sample begins to flow out Tfb and the temperature at which the flow is stopped Tend.

The toner particles may have excellent fixing properties at a low temperature if T_{g} is in the range of 50 to 60° C. The toner particles may have excellent cleaning properties and glossing properties if T_{1/2}-T_{g} is in the range of 50 to 100° C.

The binder resin contained in the toner particles according to the current embodiment may be prepared by polymerizing at least one polymerizable monomer selected from the group consisting of a vinyl-based monomer, a polar monomer having a carboxy group, a monomer having an ester group, and a monomer having a fatty acid group. The polymerizable monomer may include at least one monomer selected from the group consisting of styrene-based monomers such as styrene, vinyl toluene, and α-methyl styrene; acrylic acid or methacrylic acid; derivatives of (meth)acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, di methylaminoethyl methacrylate, acrylonitrile, methacrylonitrile, acrylamide, and metacryl amide; ethylenically unsaturated mono-olefins such as ethylene, propylene, and butylenes; halogenated vinyls such as vinyl chloride, vinylidene chloride, and vinyl fluoride; vinyl esters such as vinyl acetate and vinyl propionate; vinyl ethers such as vinyl methyl ether and vinyl ethyl ether; vinyl ketones such as vinyl methyl ketone and methyl isoprophenyl ketone; and nitrogen-containing vinyl compounds such as 2-vinylpyridine, 4-vinylpyridine, and N-vinyl pyrrolidone, but is not limited thereto.

Generally, a polymerization initiator may be used to initiate the polymerization. Examples of the polymerization initiator are a benzoyl peroxide-based polymerization initiator and an azo-based polymerization initiator.

More particularly, the polymerization initiator may be selected from the group consisting of: an azo-based polymerization initiator such as 2-2′-azobisisobutyronitrile; ketone peroxide such as methylethylketoneperoxide; peroxyketal such as 1,1-bis(t-butylperoxy)-3,3,5-trimethylcyclohexane; hydroperoxide such as t-butylhydroperoxide; dialkylperoxide such as di-t-butylperoxide; diacylperoxide such as isobutylperoxide; peroxydicarbonate such as di-isopropylperoxy dicarbonate; sulfonyl peroxide such as acetylcyclohexylsulfonyl peroxide; and peroxyester such as t-butylperoxy acetate.

A portion of the binder resin may be subjected to a reaction with a cross-linking agent, such as an isocyanate compound and an epoxy compound. A cross-linked resin is formed by the cross-linking of the binder resins using the cross-linking agent, and the amount of the cross-linked resin contained in the toner may be in the range of 5 to 30 parts by weight based on 100 parts by weight of the uncross-linked binder resin. If the amount of the cross-linked resin is less than 5 parts by weight based on 100 parts by weight of the uncross-linked binder resin, fixing temperature range decreases due to too small molecular weight. If the amount of the cross-linked resin is greater than 30 parts by weight based on 100 parts by weight of the uncross-linked binder resin, the binder resin is too rigid to be fixed at a low temperature.

The colorant contained in the toner particles may be used in the form of a pigment itself, or alternatively, in the form of a pigment master batch in which the pigment is dispersed in a resin.

The pigment may be selected from pigments that are commonly and commercially used, such as a black pigment, a cyan pigment, a magenta pigment, a yellow pigment, and a mixture thereof.

The amount of the colorant may be sufficient to color the toner and form a visible image by development, for example, in the range of 1 to 20 parts by weight based on 100 parts by weight of the binder resin.

Meanwhile, the toner particles may further include additives in addition to the binder resin and the colorant. The additives may include a releasing agent such as wax, a charge control agent, or the like.

The charge control agent may be a negative charge control agent or a positive charge control agent. Examples of the negative charge control agent include an organic metal complex or a chelate compound; a salicylic acid compound containing metal; and organic metal complexes of an aromatic hydroxycarboxylic acid and an aromatic dicarboxylic acid, and any known negative charge control agent may also be used without limitation. Examples of the positive charge control agent include nigrosine and products of nigrosine modified with a fatty acid metal salt, an onium salt including a quaternary ammonium salt, and any mixture thereof. Since the charge control agent stably and quickly charges a toner by its electrostatic force, the toner may be stably supported on a developing roller.

The amount of the charge control agent contained in toner may be in a range of about 0.1 parts by weight to about 10 parts by weight based on 100 parts by weight of an entire toner composition. The entire toner composition, used herein, refers to a toner composition including all elements including an external additive in addition to the binder resin, the colorant, and the additives.

Wax improves fixing properties of a toner image. Examples of the wax include polyalkylene wax such as low molecular weight polypropylene and low molecular weight polyethylene, ester wax, carnauba wax, and paraffin wax. The amount of the wax contained in toner may be in a range of about 0.1 parts by weight to about 30 parts by weight based on 100 parts by weight of the entire toner composition. If the amount of the wax is less than 0.1 parts by weight, oilless fixing of toner particles in which toner particles are fixed without using oil cannot be performed. On the other hand, if the amount of the wax is greater than 30 parts by weight, toner may be flocculated while it is stored.

The additives may further include external additives. The external additives are used to improve fluidity of the toner or control charge properties of the toner. Examples of the external additives include large particulate silica, small particulate silica, and polymer beads.

The toner particles according to the current embodiment may be prepared by using various methods. In other words, any method of preparing toner particles having the above-mentioned properties which is commonly used in the art may be used.

For example, the toner particles may be manufactured in the following manner. A coagulant is added to a mixture including a latex, a colorant dispersion, and a wax dispersion. Then, the mixture is homogenized and aggregated to prepare toner particles. That is, the latex, the colorant dispersion, and the wax dispersion are added to a reactor. The coagulant is added thereto, and the mixture is homogenized at a stirring line speed of 1.0 to 2.0 m/s at a temperature of 20 to 30° C. for 10 to 100 minutes while controlling the pH in the range of 1.5 to 2.3. Then, the reactor is heated to a temperature in the range of 48 to 53° C. and stirred at a stirring line speed of 1.0 to 2.5 m/s to perform aggregation.

The aggregated particles are fused, cooled, and dried to obtain desired toner particles. The dried toner particles are treated with external additives using, for example, silica, and a charge quantity thereof is adjusted to obtain desired toner for a laser printer.

The toner particles according to the current embodiment may have a core-shell structure. The toner having the core-shell structure may be prepared using a method including: preparing a primary aggregated toner by adding a coagulant into a mixture of a latex for a core, a colorant dispersion, and a wax dispersion, and homogenizing and aggregating the mixture; forming a shell by adding a latex for a shell to the primary aggregated; and fusing the structure.

According to another embodiment of the present invention, a developer for developing an electrostatic image including the toner particles and a magnetic carrier is provided. The magnetic carrier is a carrier having a surface coated with an insulating material. Particularly, the magnetic carrier is a carrier used for a two-component development and may include ferrite coated with an insulating material, magnetite coated with an insulating material, iron powder coated with an insulating material, or any mixture thereof. For example, the ferrite coated with an insulating material or the magnetite coated with an insulating material may efficiently be used.

According to another embodiment of the present invention, a method of forming an electrophotographic image using the toner particles is provided.

Particularly, the method includes forming a toner image by adhering the toner or the developer for developing an electrostatic image to a photoreceptor on which an electrostatic image is formed, and transferring the toner image to a transfer medium.

The toner or the developer for developing an electrostatic image according to the current embodiment is used in an apparatus for forming an electrophotographic image. In this regard, the apparatus for forming an electrophotographic image includes laser printers, photocopiers, facsimiles, or the like.

Hereinafter, one or more embodiments will be described in detail with reference to the following examples. However, these examples are not intended to limit the purpose and scope of the invention.

Average Particle Diameter

Average particle diameter of toner was measured using a Multisizer 3 Coulter Counter. An aperture of 100 μm was used in the Multisizer 3 Coulter Counter, an appropriate amount of a surfactant was added to 50 to 100 ml of ISOTON-II (Beckman Coulter Inc.) as an electrolyte, and 10 to 15 mg of a sample to be measured was added thereto, and the resultant was dispersed in a ultrasonic dispersing apparatus for 5 minutes to prepare a sample.

Glass Transition Temperature (Tg, ° C.)

A glass transition temperature Tg of a sample was measured using a differential scanning calorimeter DSC (manufactured by Netzsch Co.) by heating the sample from 20 to 200° C. at 10° C./min, rapidly cooling the sample to 10° C. at 20° C./min, and heating the sample at 10° C./min.

Acid Value

An acid value (mgKOH/g) was measured by dissolving a resin in dichloromethane, cooling the solution and titrating the solution with 0.1 N KOH methyl alcohol solution.

Molecular Weight

A molecular weight was measured by using a gel permeation chromatography (Waters Alliance GPC 2000 systems).

Tetrahydrofuran (THF) was used as a solvent, and a calibration curve was obtained by using standard polystyrene.

### Example 1

### Preparation of Latex for Core and Shell

A 30 L reactor equipped with a stirrer, a thermometer, and a condenser was installed in an oil bath in which the oil is a heat transfer medium. 6,600 g of distilled water and 32 g of a surfactant (Dowfax 2A1) were added to the reactor, and the reactor was heated to 70° C. and stirred at 100 rpm. Then, an emulsion mixture, including monomers, i.e., 8,380 g of styrene, 3,220 g of butyl acrylate, 370 g of 2-carboxyethyl acrylate, and 226 g of 1,10-decanediol diacrylate, 5,075 g of distilled water, 226 g of the surfactant (Dowfax 2A1), 530 g of polyethylene glycol ethyl ether methacrylate, as a macro monomer, and 188 g of 1-dodecanethiol, as a chain transfer agent, was stirred at 400 to 500 rpm for 30 minutes using a disc-type impeller. Then, the emulsion mixture was gradually added to the reactor for 1 hour. The reactor was maintained for about 8 hours and gradually cooled to room temperature to complete the reaction.

The glass transition temperature Tg of the binder resin measured using a DSC was 62° C. The number average molecular weight of a binder resin measured by a gel permeation chromatography (GPC) using polystyrene as a standard sample was 50,000.

Preparation of Pigment Dispersion

540 g of a cyan pigment (Daicolor Pigment MFG. Co. Ltd., Japan, ECB303), 27 g of a surfactant (Dowfax 2A1), and 2,450 g of distilled water were added to a 3 L reactor equipped with a stirrer, a thermometer, and a condenser, and the reactor was slowly stirred for about 10 hours to obtain a pre-dispersion. The pre-dispersion was further dispersed using a beads mill (Netzsch, Germany, Zeta RS) for 4 hours. As a result, a cyan pigment dispersion was obtained.

Then, the particle size of the cyan pigment was measured using a Multisizer 2000 (Malvern Instruments, Ltd.), and D50(v) was 170 nm. In this regard, when the volume of the particles is accumulated from particles of the smallest size in ascending order until the accumulated volume reaches 50% of the total volume of the particles, an average particle size of the accumulated particles corresponding to 50% of the total volume of the particles is defined as D50(v).

Preparation of Wax Dispersion

65 g of a surfactant (Dowfax 2A1), and 1,935 g of distilled water were added to a 5 L reactor equipped with a stirrer, a thermometer, and a condenser, and 1,000 g of wax (NOF Corporation, Japan, WE-5) was added to the reactor while slowly stirring the reactor at a high temperature for about 2 hours. The wax was dispersed for 30 minutes using a homogenizer (IKA, T-45). As a result, a wax dispersion was obtained.

Then, the particle size of the wax was measured using a Multisizer 2000 (Malvern Instruments, Ltd.), and D50(v) was 320 nm.

Preparation Toner Particles

60.0 parts by weight of the latex for a core, 5.0 parts by weight of the colorant dispersion, and 10 parts by weight of the wax dispersion were added to a 70 L reactor, and the mixture was mixed at room temperature for about 15 minutes at 50 rpm. 2.0 parts by weight of a solution including poly silicato iron (PSI) and nitric acid (PSI/1.88% HNO₃=½), as a coagulant, was added to the reactor, and then the mixture was homogenized using a homogenizer (IKA, T-45) while stirring the reactor at 25° C. at 50 rpm (at a stirring line speed of 1.79 m/sec) for 30 minutes while controlling the pH in the range of 1.3 to 2.3. After stirring the reactor for 30 minutes, the temperature of the reactor was increased to 51° C. and stirred at 115 rpm to perform aggregation. The aggregation was continued until an average particle diameter of the toner particles was in the range of 6.3 to 6.4 μm, and 25 parts by weight of the latex for a shell was added thereto for about 20 minutes. The reactor was stirred until an average particle diameter of the toner particles was in the range of 6.7 to 6.9 μm. A 4% sodium hydroxide aqueous solution was added to the reactor and the reactor was stirred at 70 rpm until the pH reached 4 and at 60 rpm until the pH reached 7. While maintaining the stirring speed, the reactor was heated to 96° C. to fuse the toner particles. When circularity measured using an FPIA-3000 (Sysmex Co., Japan) was 0.980, the reactor was cooled to 40° C., and the pH of the mixture was adjusted to 9.0. Then, the toner particles were isolated using SUS (pore size: 20 μm) and cleaned four times using distilled water. The pH of the toner particles was adjusted to 1.5 by using a 1.88% nitric acid aqueous solution and the toner particles were cleaned. The toner particles were cleaned four times with distilled water to remove a surfactant, or the like. Then, the cleaned toner particles were dried in a fluidized bed dryer at 40° C. for 5 hours to obtain dried toner particles.

### Examples 2 to 3 and Comparative Examples 1 to 3

Toner particles were obtained in the same manner as in Example 1, except that the ratio of styrene and butyl acrylate was adjusted as shown in Table 1 below when the latex for a core and the latex for a shell were prepared.

TABLE 1

| | | | | Com- | Com- | Com- |
|---|---|---|---|---|---|---|
| | | | | par- | par- | par- |
| | | | | ative | ative | ative |
| | Exam- | Exam- | Exam- | Exam- | Exam- | Exam- |
| | ple 1 | ple 2 | ple 3 | ple 1 | ple 2 | ple 3 |
| Styrene(g)/ | 2.60 | 2.50 | 2.70 | 1.00 | 4.00 | 5.00 |
| butyl acrylate | | | | | | |
| (g) | | | | | | |

T_{1/2} and T_{g} of the toner particles prepared according to Examples 1 to 3 and Comparative Examples 1 to 3 are shown in Table 2 below.

A T_{1/2} according to the current embodiment was obtained using the load extrusion-type capillary rheometer under the following conditions.

Piston Cross-sectional Area: 1 cm²

Cylinder Pressure: 0.98 Mpa

Length of Die: 1 mm, Diameter of Die Hole: 0.5 mm

Measurement Initiation Temperature: 90° C.

Temperature Raising Rate: 3° C./min

Weight of Sample: 1.5 g

TABLE 2

| | T_{1/2} (□) | T_{g} (□) |
|---|---|---|
| Example 1 | 135 | 60 |
| Example 2 | 140 | 55 |
| Example 3 | 130 | 58 |
| Comparative Example 1 | 115 | 70 |
| Comparative Example 2 | 200 | 50 |
| Comparative Example 3 | 210 | 45 |

The toner particles prepared according to Examples 1 to 3 and Comparative Examples 1 to 3 were evaluated as follows.

Evaluation of Fixing Properties

Equipment: belt-type fixing device

Unfixed images for a test: 100% pattern

Test temperature: 160° C.

Speed: 160 mm/sec

Dwell time: 0.08 sec

9.75 g of toner particles prepared in any of Examples 1 to 3 and Comparative Examples 1 to 3, 0.2 g of silica (TG 810G; Cabot Co.) and 0.05 g of silica (RX50, Degussa GmbH) were mixed to prepare a toner. Using the toner, fixed images were formed. Then, the fixing properties of the unfixed images were evaluated while varying the temperature of a fixing roller of a fixing tester in which the fixing temperature was controllable. After measuring optical density (OD) of the fixed image, a 3M 810 Scotch tape was adhered to a portion of the image, and the tape was removed after reciprocating five times using a 500 g weight. The OD of the fixed image was measured after removing the tape. Fixing properties were evaluated according to the following equation.

Fixability (%)=[(OD after removing tape)/(OD before removing tape)]*100

A fixing temperature range having a fixability value of 90% or more was regarded as a fixing range of a toner.

Minimum Fusing Temperature (MFT): minimum temperature having the fixability value of 90% or more without cold-offset

Hot Offset Temperature (HOT): minimum temperature at which hot-offset occurs

Evaluation of Cleaning Properties

9.75 g of toner particles prepared in Examples 1 to 3 and Comparative Examples 1 to 3, 0.2 g of silica (TG 810G; Cabot Co.), and 0.05 g of silica (RX50; Degussa GmbH) were mixed to prepare a toner. Using the toner, 100 pages of image concentration charts were printed using a Samsung CLP-510 printer. Then, toner remaining on the photoreceptor that has passed through a cleaning blade was transferred onto white paper using a Scotch tape and measured using X-Rite938 (X-rite). The results were compared with blank paper.
⊙: difference from blank less than 0.005
◯: difference from blank in the range of 0.005 to 0.010
Δ: 0.011 to 0.02
X: greater than 0.02

Evaluation of Glossing Properties

Equipment: belt-type fixing device

Unfixed images for test: 100% pattern

Test temperature: 160° C.

Speed: 160 mm/sec

Dwell time: 0.08 sec

9.75 g of toner particles prepared in any of Examples 1 to 3 and Comparative Examples 1 to 3, 0.2 g of silica (TG 810G; Cabot Co.) and 0.05 g of silica (RX50, Degussa GmbH) were mixed to prepare a toner. Using the toner, fixed images were formed. Then, glossing properties of the images was measured.

Measurement angle: 90° C.

The results of the evaluation are shown in Table 3 below.

TABLE 3

| | | | | Comparative | Comparative | Comparative |
|---|---|---|---|---|---|---|
| | Example 1 | Example 2 | Example 3 | Example 1 | Example 2 | Example 3 |
| Fixing | 140~210 | 140~210 | 140~210 | 150~190 | 150~190 | 140~190 |
| temperature | | | | | | |
| range (□) | | | | | | |
| Cleaning | □ | □ | □ | □ | X | X |
| Properties | | | | | | |
| glossing | 10.2 | 11.4 | 11.2 | 6.8 | 10.2 | 10 |
| properties | | | | | | |

As shown in Table 3, toner particles prepared in Examples 1 to 3 according to embodiments of the present invention have excellent fixing properties at a low temperature, excellent cleaning properties, and excellent glossing properties.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. Toner particles comprising a binder resin, a releasing agent, and a colorant, wherein T_{1/2} obtained using a load extrusion-type capillary rheometer and a glass transition temperature T_{g} satisfy the following conditions:
50° C.≦T_{1/2}−T_{g}≦100° C. (1)
50° C.≦T_{g}≦60° C. (2)

2. The toner particles of claim 1, wherein the binder resin comprises a styrene residue.

3. A developer for developing an electrostatic image: comprising toner particles according to claim 1; and a carrier.

4. The developer of claim 3, wherein the carrier comprises at least one selected from the group consisting of ferrite coated with an insulating material, magnetite coated with an insulating material, and iron powder coated with an insulating material.

5. A method of forming an electrophotographic image, the method comprising forming a toner image by adhering toner to a photoreceptor on which an electrostatic image is formed, and transferring the toner image to a transferring medium, wherein the toner comprises toner particles according to claim 1.

6. A developer for developing an electrostatic image: comprising toner particles according to claim 2; and a carrier.

7. A method of forming an electrophotographic image, the method comprising forming a toner image by adhering toner to a photoreceptor on which an electrostatic image is formed, and transferring the toner image to a transferring medium, wherein the toner comprises toner particles according to claim 2.
